(19) United States
(12) Patent Application Publication
(10) Pub. No.: US 2013/0200218 A1
(43) Pub. Date: Aug. 8, 2013

(54) ROTORCRAFT ESCAPE SYSTEM

(71) Applicant: BONG H. SUH, ROCKVILLE, MD (US)

(72) Inventor: BONG H. SUH, ROCKVILLE, MD (US)

(21) Appl. No.: 13/762,258

(22) Filed: Feb. 7, 2013

Related U.S. Application Data
(60) Provisional application No. 61/596,681, filed on Feb. 8, 2012.

(51) Int. Cl. B64D 17/72

(52) U.S. Cl. CPC B64D 17/72
USPC 244/146

(57) ABSTRACT

The rotorcraft escape system is deployed from a helicopter or gyroplane to provide clearance from the overhead rotor blades for occupants escaping from the aircraft in an emergency. Each occupant of the rotorcraft is provided with an escape container having a parachute and ejection device (rocket, spring, or combination of the two) therein. When escape from the rotorcraft occurs, each seat of the rotorcraft rotates to face laterally outward, and the ejection mechanism of the escape container is actuated to eject the container and the person wearing the container laterally from the rotorcraft. An inflatable stem extends from the escape container to a plurality of inflatable ribs in the canopy. A compressed air tank provided with the container rapidly inflates the pneumatic stem and ribs in the parachute canopy, thereby providing extremely rapid deployment of the parachute canopy with minimal loss of altitude for the escaping occupant.

### CROSS-REFERENCE TO RELATED APPLICATION

This application claims the benefit of U.S. Provisional Patent Application Ser. No. 61/596,681, filed Feb. 8, 2012.

### BACKGROUND OF THE INVENTION

1. Field of the Invention

The present invention relates to aviation safety devices and systems, and particularly to a rotorcraft escape system providing lateral ejection and rapidly opening parachute deployment for the occupants of a helicopter or other rotorcraft.

2. Description of the Related Art

Aircraft operate using a number of different physical and/or aerodynamic principles. Among these are rotorcraft that fly by means of a rotary wing or wings that rotate to provide the rotor airspeed necessary to produce lift. There are two general classes of rotorcraft: (1) helicopters, and (2) gyroplanes, sometimes referred to as Gyrocopters®. While helicopters drive their rotors by means of an engine, gyroplanes rely upon forward movement through the air to generate the rotary action of their rotors. The primary point in common between both of these classes of aircraft is that their rotor(s) extends above the aircraft and rotates in at least a generally horizontal plane.

While a fixed wing military aircraft provides overhead clearance for ejection from the aircraft, the overhead rotor(s) of all rotorcraft are clearly an impediment to overhead or vertical departure from such an aircraft in an emergency. Either some means must be provided to remove the rotor blades from above the occupants of the aircraft, or some means must be provided to deliver the occupants safely to some distance beyond the radius of the rotor blades before the rotorcraft descends below the level of the departed occupants. Moreover, as most rotorcraft operate at relatively low altitudes and a lateral ejection system for the occupants would preclude any gain of altitude during the ejection, some means must be provided to enable the parachute to deploy considerably more rapidly than conventional practice.

Thus, a rotorcraft escape system solving the aforementioned problems is desired.

### SUMMARY OF THE INVENTION

The rotorcraft escape system enables the occupants of a rotary wing aircraft (helicopter or gyroplane) to escape the aircraft in the event of an airborne emergency. The system comprises an escape container or backpack to be worn by each occupant of the rotorcraft, the container having an ejection device and a rapidly deployable parachute therein. The seats of the rotorcraft are specially configured to orient the occupants for escape from the rotorcraft, although the seats remain in the rotorcraft after the occupants have escaped.

The escape container includes a device for generating thrust sufficient to push the container and its occupant laterally from the rotorcraft after the seat has rotated to align the occupant laterally for lateral ejection from the rotorcraft. The thrust-generating means may comprise a rocket, a powerful spring, or some combination of a rocket and spring.

Once the occupant has escaped the rotorcraft, the parachute is deployed. The escape container includes a container of pressurized gas therein, e.g., carbon dioxide or other gas, that inflates a series of tubular elements extending from the container to the parachute canopy, and across the parachute canopy. The resulting rapid deployment of the parachute results in minimal loss of altitude for the occupant from the time he or she leaves the aircraft to the time the parachute is fully deployed. Alternatively, the rotorcraft occupant may connect a hand carried container of pressurized gas to the parachute inflation system of the escape container.

These and other features of the present invention will become readily apparent upon further review of the following specification and drawings.

### BRIEF DESCRIPTION OF THE DRAWINGS

FIG. 1A is an environmental, perspective view of a rotorcraft escape system according to the present invention, illustrating its installation in a helicopter.

FIG. 1B is an environmental perspective view of a rotorcraft wherein the occupants are shown escaping the rotorcraft using the rotorcraft escape system according to the present invention.

FIG. 2 is an environmental side elevation view of a rotorcraft occupant shown wearing an escape container of the rotorcraft escape system according to the present invention, the escape container having a rocket escape device therein.

FIG. 3 is an environmental side elevation view of a rotorcraft occupant shown wearing an escape container of the rotorcraft escape system according to the present invention, the escape container having a spring escape device therein.

FIG. 4 is an environmental side elevation view of a rotorcraft occupant shown wearing an escape container of the rotorcraft escape system according to the present invention, the escape container having a combination rocket and spring escape device therein.

FIG. 5A is a side elevation view in section of an ejected occupant seat and deployed parachute of the rotorcraft escape system according to the present invention, illustrating a first embodiment of the pneumatic inflation tubes or lines within the parachute.

FIG. 5B is a side elevation view in section of an ejected occupant seat and deployed parachute of the rotorcraft escape system according to the present invention, illustrating a second embodiment of the pneumatic inflation tubes or lines within the parachute.

FIG. 6A is a top plan view of the deployed parachute of the rotorcraft escape system according to the present invention, showing the radially disposed pneumatic inflation tubes in the deployed parachute canopy of FIG. 5A.

FIG. 6B is a top plan view of the deployed parachute of the rotorcraft escape system according to the present invention, showing the radially disposed pneumatic inflation tubes in the deployed parachute canopy of FIG. 5B.

FIG. 7 is a front elevation view in section of an escape container of the rotorcraft escape system according to the present invention having a single parachute inflation nozzle therein for inflating the central stem of the parachute.

FIG. 8 is a front elevation view in section of an escape container of the rotorcraft escape system according to the present invention having multiple parachute inflation nozzles therein for inflating the tubular ribs of the parachute.

Similar reference characters denote corresponding features consistently throughout the attached drawings.

### DETAILED DESCRIPTION OF THE PREFERRED EMBODIMENTS

The rotorcraft escape system provides for occupant escape from an inflight rotorcraft, e.g., a helicopter or a gyroplane, by ejecting the occupant laterally from the aircraft to a distance beyond the radius of the rotor(s) before parachute deployment. The parachute includes inflation tubes therein. Compressed gas provides rapid deployment of the parachute to minimize altitude loss for the seated occupant.

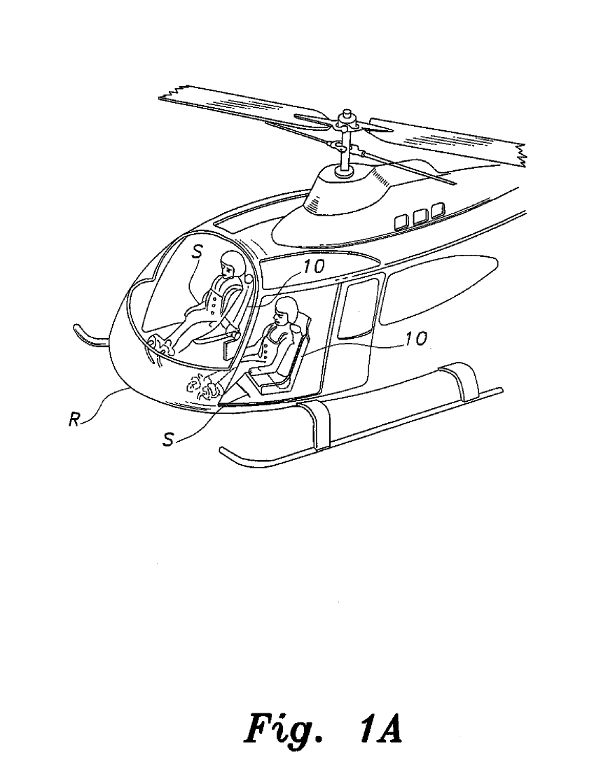

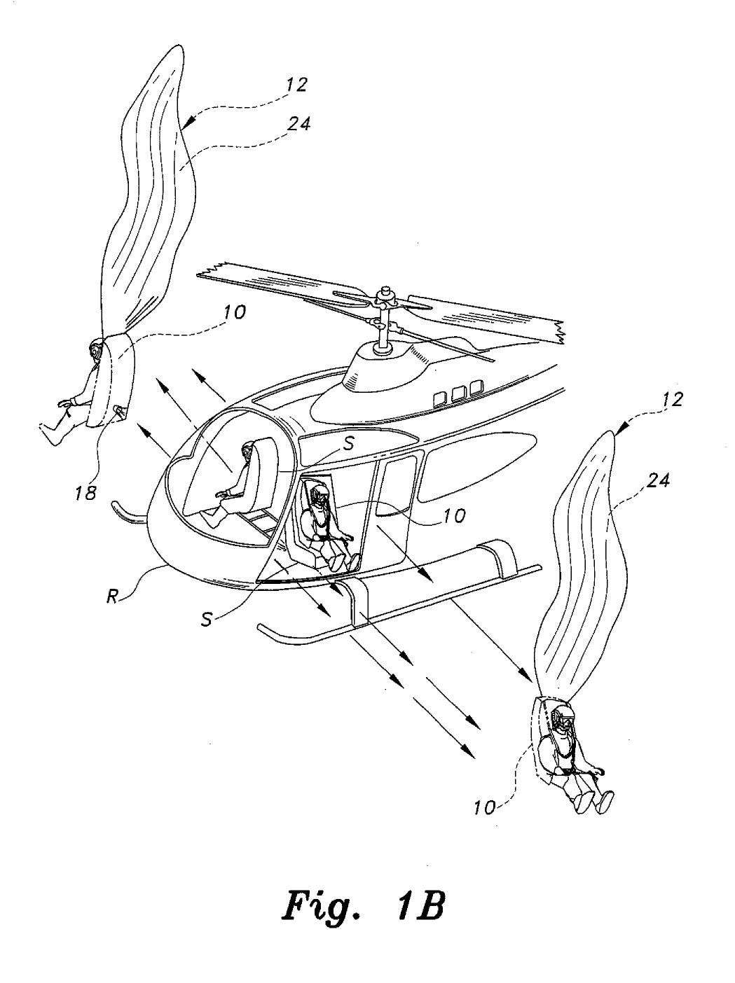

FIG. 1A of the drawings provides an environmental perspective view of an exemplary helicopter (rotorcraft R), in which both occupants or flight crewmembers are provided with an escape container 10. Each of the occupants is seated within a specially configured seat S that rotates about a vertical axis to turn the occupant seated thereon to face outwardly for ejection from the rotorcraft R.

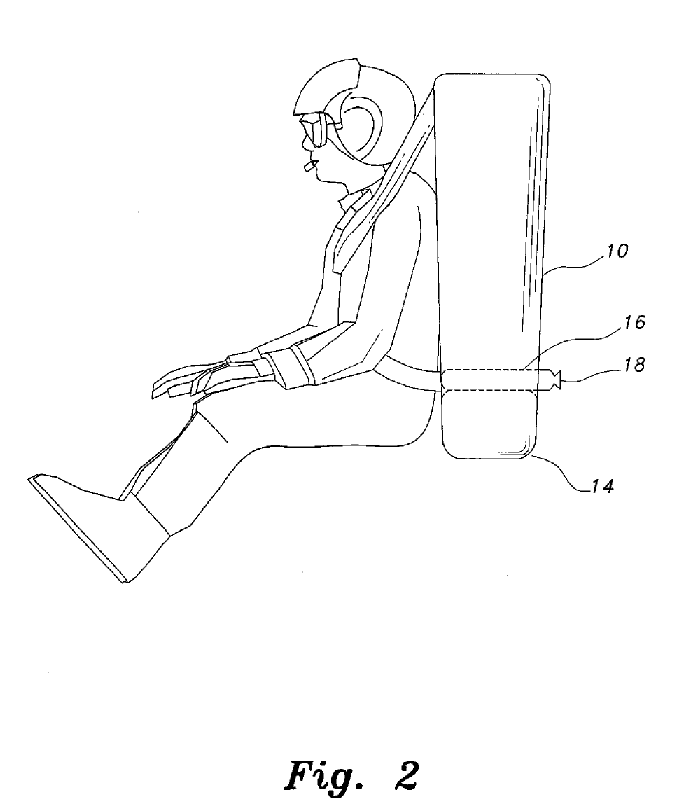

FIG. 1B illustrates the ejection procedure from the rotorcraft R. In FIG. 1B, each seat S has rotated 90°, the left hand seat rotating counterclockwise and the right hand seat rotating clockwise. This reorientation of the two seats S results in the occupant of each seat facing laterally outward from the rotorcraft R. At this point, an ejection device (embodiments of which are illustrated in FIGS. 2 through 4 and discussed further below) is actuated to launch the escape container 10 from each of the seats S, as shown in FIG. 1B. The escape containers 10 are shown in broken lines after having been ejected laterally from the helicopter or rotorcraft R to a lateral distance beyond the rotor blades of the rotorcraft R. (The blades are shown only partially, to conserve space in the drawing).

FIGS. 1 through 5 illustrate the various thrust devices that may be provided to drive the occupants and their escape containers 10 laterally from the rotorcraft R. Two different principles are described herein, and a third embodiment is a hybrid of the two. The basic escape container 10 is the same for each of the different embodiments, only the thrust device differing in FIGS. 2 through 4.

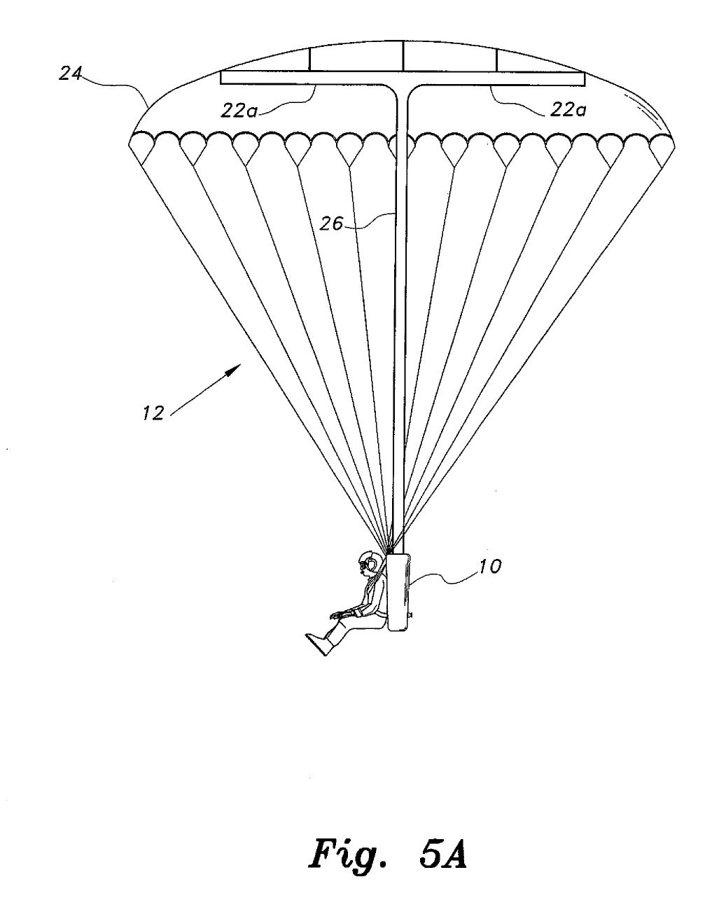

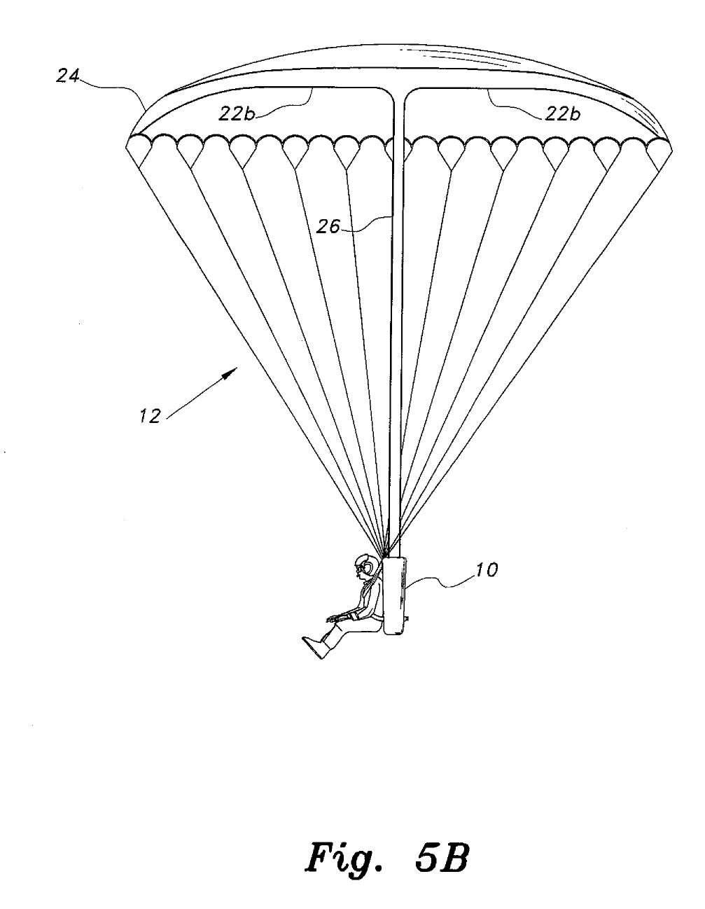

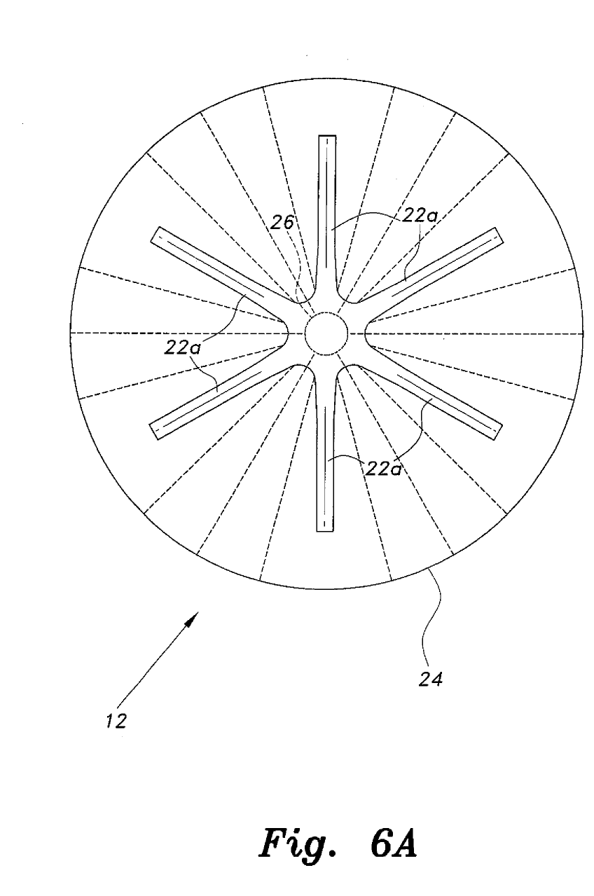

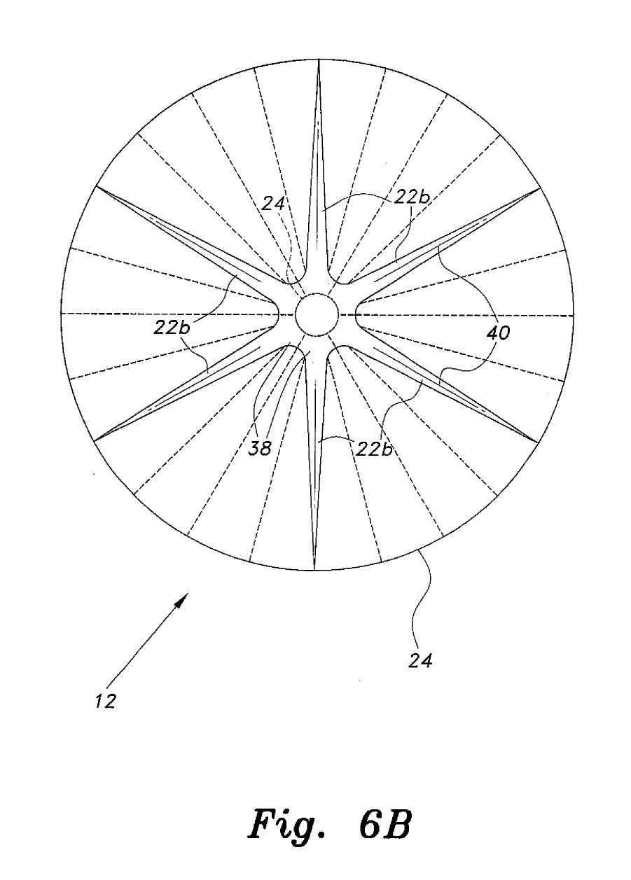

FIG. 2 of the drawings provides a left side elevation view of an occupant 0 of the rotorcraft wearing or harnessed to an escape container 10. The escape container 10 is packed with a parachute 12 (not shown in FIG. 2, but shown partially open in FIG. 1B and in its fully deployed state in the embodiments of FIGS. 5A through 6B). A container of compressed gas 14 (e.g., CO₂) is provided with the escape container 10, e.g., installed within its base. Alternatively, the compressed gas container may be a portable unit carried by each occupant of the rotorcraft and connected to the pneumatic parachute deployment system of the escape container when the occupants board the rotorcraft.

The escape container 10 of FIG. 2 is equipped with a rocket 16 installed therein, preferably installed along a longitudinal axis at least approximately aligned with the combined center of mass of the occupant and escape container 10. The thrust axis of the rocket 16 is oriented rearward from the escape container 10. The rocket 16 has a nozzle 18 extending rearward from the escape container 10 to provide forward thrust (relative to the longitudinal axis of the occupant and his escape container 10) in order to drive the escape container 10 laterally from the rotorcraft R when the seats S are rotated, as shown in FIG. 1B. The use of a rocket 16 may be preferred, as the duration of the thrust propelling the escape container 10 may be continued for the duration of lateral travel of the escape container 10 and its occupant, thereby reducing the average accelerative force to be experienced by the occupant.

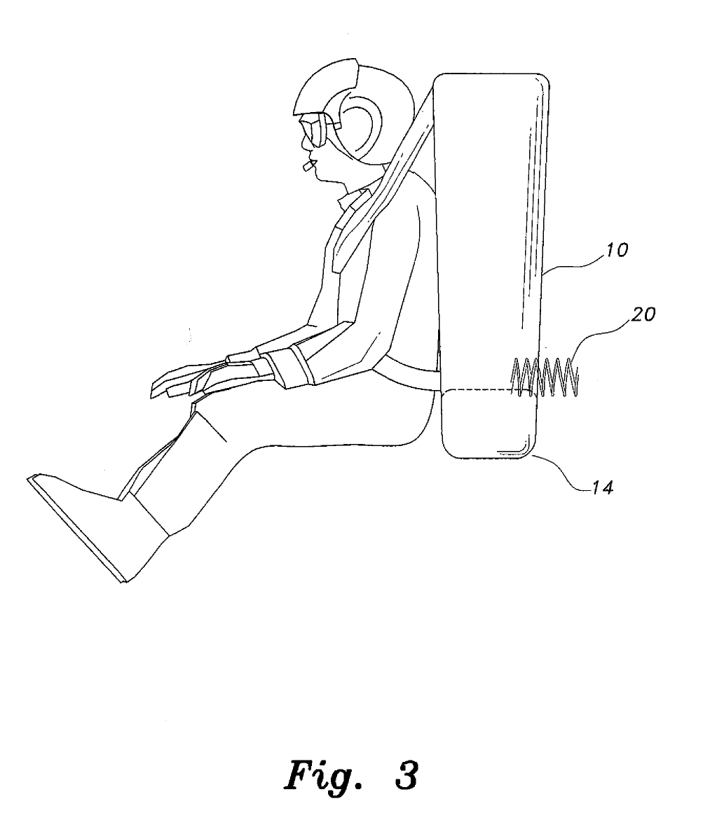

FIG. 3 of the drawings illustrates an alternative embodiment of the system in which the thrust device providing for ejection of the escape container 10 and its occupant is a spring. In FIG. 3, each escape container 10 is provided with a strong coil spring 20 compressed to the rear of the escape container. The springs 20 are held in compression during normal operations to bear against their respective seats. The compressive force is released upon command to eject the escape container 10 laterally from the rotorcraft R immediately after rotation of the seat S.

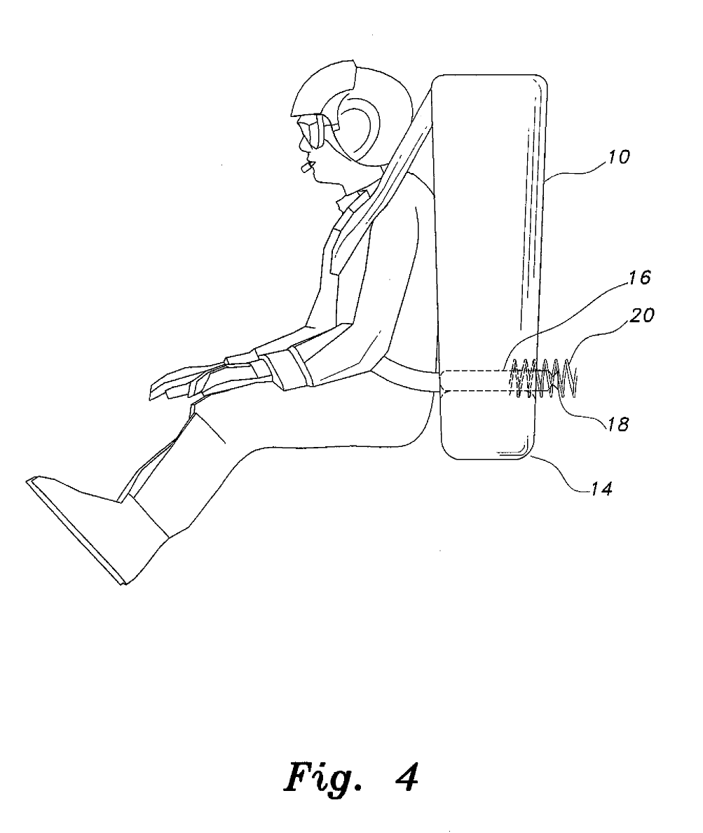

FIG. 4 of the drawings illustrates a hybrid thrust device, comprising a rocket 16 in combination with a coil spring 20 disposed concentrically about the nozzle 18 of the rocket. This system provides rapid initial acceleration for the escape container 10 and its occupant, and the rocket 16 then continues to fire to provide for the lateral ejection of the escape container and occupant to a lateral distance sufficient to clear the rotor blades of the rotorcraft.

Actuation of the system may be by conventional means, e.g., a handle or the like actuated by each crewmember or occupant, the handle triggering a pyrotechnic charge to actuate the rocket 16 and/or a mechanical release to release the compression of the spring 20. The parachute 12 may be deployed by a conventional lanyard attached to the structure of the rotorcraft, the lanyard having a length sufficient to allow the escape container to travel to a point clear of the overhead rotor(s) before parachute deployment. Alternatively, other conventional parachute deployment means may be used.

FIGS. 5A through 6B illustrate side elevation and top plan views of the deployed parachute 12. The parachute 12 is equipped with a pneumatic parachute deployment system comprising a series of inflatable ribs installed within the parachute canopy 24, and a central pneumatically inflatable stem or tube 26 that extends from the escape container 10 to communicate pneumatically with the canopy ribs. FIGS. 5A and 6A illustrate a first embodiment of the inflatable ribs 22a, in which the inflatable ribs 22a have an elongate, narrow cylindrical configuration with truncated tips or ends terminating short of the periphery of the canopy 24. The embodiment of FIGS. 5B and 6B is identical to the embodiment of FIGS. 5A and 6A, except for the configuration of the inflatable ribs 22b in FIGS. 5B and 6B. The ribs 22b have a curvilinear shape, and taper toward their distal ends or tips at the periphery of the deployed parachute canopy 24. In both embodiments, compressed gas is released from the compressed gas container 14 of the escape container 10 to initially inflate the stem 26 and then the ribs 22a (FIGS. 5A and 6A) or 22b (FIGS. 5B and 6B) of the parachute canopy 24 to provide rapid deployment of the parachute 12.

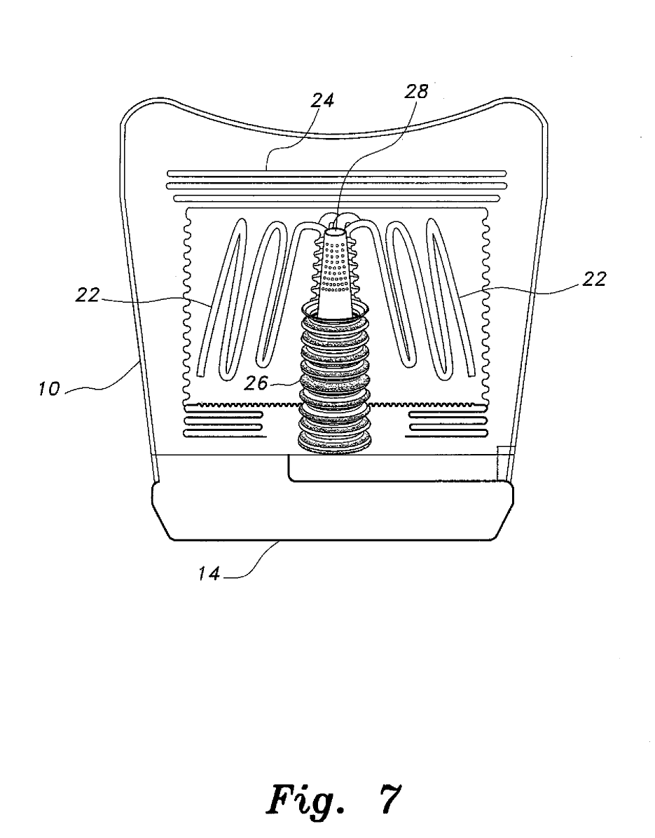

FIG. 7 is an illustration of the interior of an escape container 10 having a single inflation nozzle 28 installed therein. The central inflatable stem 26 of the parachute is shown gathered around the nozzle 28, the upper portion of the stem 26 being removed to show the inflation nozzle 28 therein. The rearward portion of the inflatable stem 26 is illustrated behind the inflation nozzle 28, and a number of the inflatable ribs 22 are shown extending from the upper end of the inflatable stem 26. The ribs 22 shown folded I FIG. 7 may comprise either the rib configuration 22a of FIGS. 5A and 6A, or the rib configuration 22b of FIGS. 5B and 6B. The parachute canopy 24 is shown folded around the inflation nozzle 28, inflation stem 26, and inflation ribs 22. The canopy shroud lines are located beneath the canopy for attachment to the structure of the escape container 10 and its occupant harness. The compressed gas container 14 is shown beneath the inflation nozzle 28.

When the pneumatic system is actuated, and once the occupant and escape container 10 are clear of the rotors of the rotorcraft, the compressed gas charge is released from the container 14 and into the perforated inflation nozzle 28, where it flows radially through the myriad small passages through the wall of the nozzle 28 to flow into the larger diameter pneumatic stem tube 26. The stem tube 26 communicates pneumatically with the plurality of pneumatically inflated ribs 22 to rapidly deploy the parachute 12 and expand the parachute canopy 24, seen most clearly in FIGS. 5A (with inflatable ribs 22a) and 5B (with inflatable ribs 22b) of the drawings.

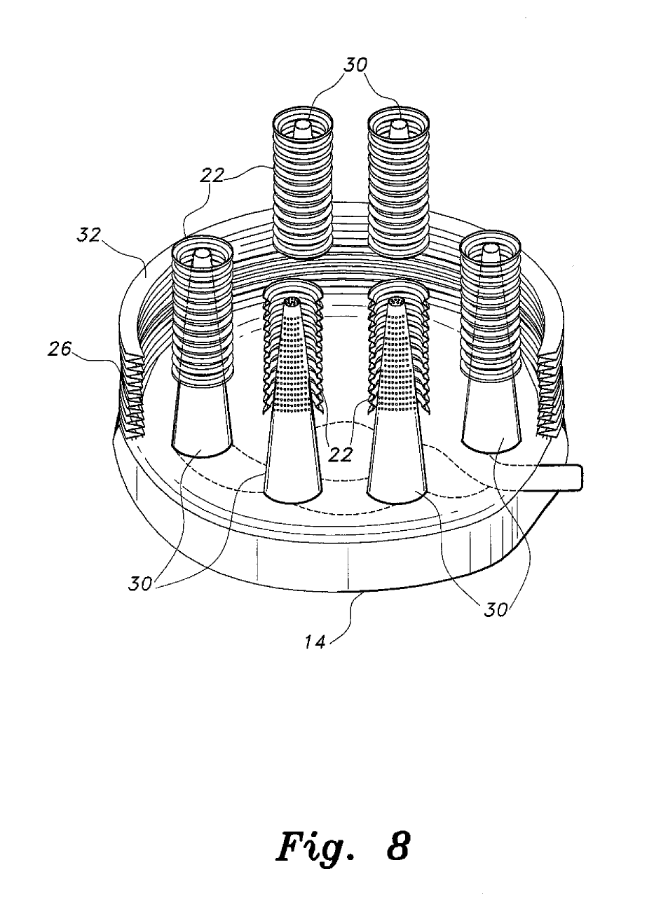

FIG. 8 provides a perspective view in partial section of an alternative embodiment of the inflation system, which comprises a plurality of separate rib inflation nozzles 30. In FIG. 8, the larger diameter inflatable stem 26 is shown gathered around the multiple rib inflation nozzles 30, and each of the inflation ribs 22 (analogous to the ribs 22a and 22b of FIGS. 5A through 6B) are gathered upon a corresponding one of the rib inflation nozzles 30. The compressed gas container 14 is located below the nozzle assembly and communicates pneumatically therewith. It will be seen in FIG. 8 that the upper or distal end 32 of the inflation stem 26 extends only partially up the lengths or heights of the rib inflation tubes 30 therein. The individual inflation ribs 22 extend from the level of the upper end 32 of the inflation stem 26 to the outer ends of their respective rib inflation nozzles 30. In practice, a closure sheet or panel would be provided from the upper or distal end 32 of the inflation stem 26 to the bases of the individual inflation ribs 22 in order to provide a pneumatically closed or sealed connection between the inflation stem 26 and inflation ribs 22. This closure panel is not shown in FIG. 8 in order to show the detail of the individual rib inflation nozzles 30.

It will be noted that the embodiment of the inflation nozzle and inflation stem and ribs of FIG. 8 comprises six rib inflation nozzles arranged in an oval or elliptical pattern. This is not necessarily required in an embodiment incorporating multiple rib inflation nozzles. For example, the inflation nozzles could be arranged in a linear array. This would permit the escape container to have a flatter configuration, i.e., thinner from front to back, in keeping with conventional backpack-type parachutes. It will also be seen that the number of inflation ribs installed in the parachute canopy may be adjusted. For example, half of the six ribs illustrated in FIGS. 6A and 6B could be deleted, depending upon the size of the parachute canopy, the speed of inflation required, the pressure of the compressed gas container, and other factors. In such a situation, only three individual rib inflation nozzles would be required. Alternatively, a greater number of inflation ribs could be provided in the parachute canopy, together with a corresponding number of individual inflation ribs provided in the escape container.

Accordingly, the rotorcraft escape system provides a safe means of ejecting rotorcraft occupants and/or crewmembers from a rotorcraft in an emergency without danger of contacting the overhead rotor(s) of the craft. The pneumatic system for rapidly deploying the parachutes of the occupants or crewmembers assures that the parachutes will deploy considerably more rapidly than would be achieved solely by latent airflow into the canopy as the parachute is ejected from its container, thereby greatly reducing the vertical distance through which the occupants and/or crewmembers fall before their parachutes are opened.

It is to be understood that the present invention is not limited to the embodiments described above, but encompasses any and all embodiments within the scope of the following claims.

I claim:

1. A rotorcraft escape system, comprising:
an escape container adapted to be worn by an occupant of the rotorcraft;
a thrust device disposed in the escape container, the thrust device selectively providing motive force for ejecting the occupant wearing the escape container;
a parachute foldably contained within the escape container, the parachute having a canopy;
a plurality of pneumatically inflatable ribs disposed radially within the canopy of the parachute; and
a container of compressed gas disposed in the escape container, the container of compressed gas communicating pneumatically with the inflatable ribs of the canopy of the parachute for selectively inflating the ribs and the canopy of the parachute.

2. The rotorcraft escape system according to claim 1, wherein:
the thrust device comprises a spring bearing rearward from the escape container; and
a selectively inflatable stem extends between the container of compressed gas and the pneumatically inflatable ribs of the canopy of the parachute.

3. The rotorcraft escape system according to claim 1, wherein:
the thrust device comprises a rocket disposed within the escape container, the rocket having a rearward-oriented nozzle; and
a selectively inflatable stem extends between the container of compressed gas and the pneumatic parachute deployment system of the canopy of the parachute.

4. The rotorcraft escape system according to claim 1, wherein the thrust device comprises a rocket disposed within the escape container, the rocket having a rearward-oriented nozzle, the rocket having a coil spring concentrically surrounding the nozzle, the spring bearing rearward from the escape container.

5. The rotorcraft escape system according to claim 1, further comprising:
a single inflation nozzle disposed within the escape container, the inflation nozzle selectively communicating pneumatically with the container of compressed gas; and
a selectively inflatable stem extending between the inflation nozzle and the pneumatically inflatable ribs of the canopy of the parachute, the container of compressed gas selectively inflating the stem and the pneumatically inflatable ribs.

6. The rotorcraft escape system according to claim 1, further comprising:
a plurality of inflation nozzles disposed within the escape container, each of the inflation nozzles selectively communicating pneumatically with the container of compressed gas; and
a plurality of selectively inflatable ribs disposed within the parachute canopy, each of the ribs communicating pneumatically with a corresponding one of the inflation nozzles, the container of compressed gas selectively inflating the pneumatically inflatable ribs.

7. The rotorcraft escape system according to claim 1, wherein the compressed gas is carbon dioxide.

8. A rotorcraft escape system, comprising:
an escape container adapted to be worn by an occupant of the rotorcraft;
a coil spring disposed within the escape container, the coil spring selectively providing motive force for ejecting the occupant wearing the escape container;
a container of compressed gas disposed within the escape container;
a parachute foldably contained within the escape container, the parachute having a canopy;
a pneumatic parachute deployment system foldably contained within the canopy of the parachute; and
a selectively inflatable stem extending between the container of compressed gas and the pneumatic parachute deployment system of the canopy of the parachute, the container of compressed gas selectively inflating the stem and the pneumatic parachute deployment system.

9. The rotorcraft escape system according to claim 8, wherein the pneumatic parachute deployment system further comprises a plurality of pneumatically inflatable ribs disposed radially within the canopy of the parachute, the ribs communicating pneumatically with the stem.

10. The rotorcraft escape system according to claim 9, further comprising a single inflation nozzle disposed within the escape container, the inflation nozzle selectively communicating pneumatically with the container of compressed gas, the container of compressed gas selectively inflating the stem and the pneumatically inflatable ribs.

11. The rotorcraft escape system according to claim 9, further comprising a plurality of inflation nozzles disposed within the escape container, each of the inflation nozzles selectively communicating pneumatically with the container of compressed gas, each of the ribs communicating pneumatically with a corresponding one of the inflation nozzles, the container of compressed gas selectively inflating the pneumatically inflatable ribs.

12. The rotorcraft escape system according to claim 8, further comprising a rocket disposed within the escape container, the rocket having a rearward-oriented nozzle, the coil spring concentrically surrounding the nozzle.

13. The rotorcraft escape system according to claim 8, wherein the compressed gas is carbon dioxide.

14. A rotorcraft escape system, comprising:
an escape container adapted to be worn by an occupant of the rotorcraft;
a rocket disposed within the escape container, the rocket having a rearward-oriented nozzle;
a container of compressed gas disposed within the escape container;
a parachute foldably contained within the escape container, the parachute having a canopy;
a pneumatic parachute deployment system foldably contained within the canopy of the parachute; and
a selectively inflatable stem extending between the container of compressed gas and the pneumatic parachute deployment system of the canopy of the parachute, the container of compressed gas selectively inflating the stem and the pneumatic parachute deployment system.

15. The rotorcraft escape system according to claim 14, wherein the pneumatic parachute deployment system further comprises a plurality of pneumatically inflatable ribs disposed radially within the canopy of the parachute.

16. The rotorcraft escape system according to claim 15, further comprising a single inflation nozzle disposed within the escape container, the inflation nozzle selectively communicating pneumatically with the container of compressed gas, the container of compressed gas selectively inflating the stem and the pneumatically inflatable ribs.

17. The rotorcraft escape system according to claim 15, further comprising a plurality of inflation nozzles disposed within the escape container, each of the inflation nozzles selectively communicating pneumatically with the container of compressed gas, each of the ribs communicating pneumatically with a corresponding one of the inflation nozzles, the container of compressed gas selectively inflating the pneumatically inflatable ribs.

18. The rotorcraft escape system according to claim 14 further comprising a coil spring concentrically surrounding the nozzle of the rocket, the spring bearing rearward from the escape container.

19. The rotorcraft escape system according to claim 14, wherein the compressed gas is carbon dioxide.
